(19) United States
(12) Patent Application Publication
(10) Pub. No.: US 2025/0276617 A1
(43) Pub. Date: Sep. 4, 2025

(54) SEAT FOR A VEHICLE AND A METHOD OF OPERATING A SEAT

(71) Applicant: Remote Vans, LLC, Cincinnati, OH (US)

(72) Inventors: Daryn Hillhouse, Cincinnati, OH (US); Shawn G. Quinn, Waterford, MI (US); Giovanni S. Spagnuolo, Fenton, MI (US); David M. Tamplin, Warren, MI (US)

(21) Appl. No.: 19/068,595

(22) Filed: Mar. 3, 2025

Related U.S. Application Data
(60) Provisional application No. 63/560,146, filed on Mar. 1, 2024.

(51) Int. Cl. B60N 2/14; B60N 2/22; B60N 2/90

(52) U.S. Cl. CPC B60N 2/14; B60N 2/22; B60N 2/995

(57) ABSTRACT

A seat assembly for a motor vehicle is movable from a drive mode facing forwardly, to a sunset mode facing laterally generally ninety degrees from the drive mode. The seat assembly includes a mount surface and a seat frame. A first lever is pivotably coupled to the mount surface by a first pivot joint, and is pivotably coupled to the seat frame by a second pivot joint. A second lever is pivotably coupled to the mount surface by a third pivot joint, and is pivotably coupled to the seat frame by a fourth pivot joint. The seat frame moves relative to the mount surface about an arced path via pivotal movement of the first lever about the first and second pivot joints and via pivotal movement of the second lever about the third and fourth pivot joints, wherein the arced path does not having a single axis of pivotal movement.

### CROSS-REFERENCE TO RELATED APPLICATION

This application claims the benefit of U.S. Provisional Application Ser. No. 63/560,146, filed Mar. 1, 2024, which is incorporated herein by reference in its entirety.

### BACKGROUND

Recreational vehicles (RVs) provide a comfortable living and sleeping space that can be driven from location to location, thereby offering their users flexibility and spontaneity to conduct road trips and outdoor adventures. Such RVs include many features, such as multiple seats, a shower, a sink, a bathroom, a table, at least one bed, a refrigerator, a stove and the like. While some large RVs are substantially large, providing adequate space to accommodate all of these features, many users do not desire such large vehicles because they are difficult to operate, and difficult to park, particularly in cities. Smaller RVs may be easier to operate and park, but have a reduced interior footprint to accommodate all of the features that a user may desire.

Many small RVs include an enclosure that is located behind a driver's seat and that accommodates heating elements of the recreational vehicle. More specifically, the enclosure includes one or more heating elements for heating a cabin of the RV and also for heating water that is supplied to the shower and sink. In some existing RV designs, a sleeper seat (a seat that can unfold to form a bed) rests on top of this enclosure. In these designs, the sleeper seat is positioned immediately adjacent to a sidewall of the RV and is unable to be turned, also referred to as rotated, about a vertical axis due to interference with the sidewall, but rather, is only able to be moved between an upright seating configuration, wherein a seat back is in an upright position and a sitting surface is in a horizontal position to provide a seat surface, and a sleeping configuration, wherein the seat back is lowered to a horizontal position in generally horizontal, coplanar relation with the sitting surface.

### SUMMARY

This section provides a general summary of the disclosure, and is not a comprehensive disclosure of its full scope or all of its features.

It is an objective of the present disclosure to provide a seat assembly for a motor vehicle that moves from a drive mode, facing forward, to a sunset mode, facing laterally, without interference with a sidewall of the vehicle, while at the same time, being able to be positioned in close proximity with the sidewall to avoid occupying any more space within the motor vehicle than necessary.

It is a further objective of the present disclosure to be able to position the seat assembly in such close proximity with the sidewall, such that if purely rotational movement of a sitting surface and back rest of the seat assembly about a single fixed axis of rotation were to be attempted, the sidewall would interfere with the purely rotational movement of the sitting surface and back rest, to allow swinging movement of the sitting surface and back rest via, a swinging motion provided by a mounting assembly, from the drive mode to the sunset mode without inference with the sidewall.

In accordance with an aspect of the disclosure, a seat assembly for a motor vehicle, is movable from a drive mode facing forwardly in the motor vehicle, to a sunset mode facing laterally in the vehicle, generally ninety degrees from the drive mode. The seat assembly includes a mounting assembly having a base frame configured to be fixedly attached to a floor of the motor vehicle, and a pair of levers pivotably fixed to the base frame. A seat frame is pivotably fixed to the pair of levers, wherein the seat frame moves relative to the base frame about an arced path, wherein the arced path does not having a single axis of pivotal movement.

In accordance with an aspect of the disclosure, a seat assembly for a motor vehicle in accordance with an aspect of the disclosure is movable from a drive mode facing forwardly, to a sunset mode facing laterally generally ninety degrees from the drive mode. The seat assembly includes a mount surface and a seat frame. A first lever is pivotably coupled to the mount surface by a first pivot joint such that the first lever is pivotal relative to the mount surface about the first pivot joint. The first lever is pivotably coupled to the seat frame by a second pivot joint such that the first lever is pivotal relative to the seat frame about the second pivot joint. A second lever is pivotably coupled to the mount surface by a third pivot joint such that the second lever is pivotal relative to the mount surface about the third pivot joint. The second lever is pivotably coupled to the seat frame by a fourth pivot joint such that the second lever is pivotal relative to the seat frame about the fourth pivot joint.

In accordance with another aspect of the disclosure, the first lever and the second lever are generally parallel with one another while the seat assembly is in the drive mode, and the first lever and the second lever are in nonparallel relation with one another while the seat assembly is in the sunset mode.

In accordance with another aspect of the disclosure, the mount surface extends between opposite sides, the first pivot joint being proximate one of the opposite sides and the third pivot joint being proximate the other of the opposite sides.

In accordance with another aspect of the disclosure, the first pivot joint and the third pivot joint are decoupled from the seat frame.

In accordance with another aspect of the disclosure, the second pivot joint and the fourth pivot joint are decoupled from the mount surface.

In accordance with another aspect of the disclosure, the seat assembly has a side extending along a sidewall of the vehicle when the seat assembly is in the drive mode, wherein the sidewall does not interfere with the side of the seat assembly as the seat assembly moves between the drive mode and the sunset mode.

In accordance with another aspect of the disclosure, the side of the seat assembly is spaced from the sidewall by a first distance while the seat assembly is in the drive mode, and wherein the seat assembly has a back surface spaced from the sidewall by a second distance while the seat assembly is in the sunset mode, wherein the first distance is substantially the same as the second distance.

In accordance with another aspect of the disclosure, the seat assembly is spaced from the sidewall substantially by the first distance or substantially by the second distance throughout the entirety of the movement of the vehicle seat between the drive mode and the sunset mode.

In accordance with another aspect of the disclosure, the first lever pivots relative to the mount surface about the first pivot joint in a first direction while the seat assembly moves from the drive mode to the sunset mode and the second lever pivots relative to the mount surface about the third pivot joint in a second direction opposite the first direction while the seat assembly moves from the drive mode to the sunset mode.

In accordance with another aspect of the disclosure, the first lever pivots relative to the seat frame about the second pivot joint in the first direction while the seat assembly moves from the drive mode to the sunset mode and the second lever pivots relative to the seat frame about the fourth pivot joint in the second direction while the seat assembly moves from the drive mode to the sunset mode.

In accordance with another aspect of the disclosure, the mount surface is configured to remain fixed during movement of the seat assembly from the drive mode to the sunset mode, and the seat frame is configured to move relative to the mount surface during movement of the seat assembly from the drive mode to the sunset mode, the seat frame not having a fixed axis of rotation with the mount surface as the seat frame moves relative to the mount surface.

In accordance with another aspect of the disclosure, a fixed point on the seat frame does not rotate about a fixed point on the mount surface as the seat frame moves relative to the mount surface.

In accordance with another aspect of the disclosure, a back frame is supported by the seat frame for pivotal movement between an upright position, whereat the back frame and the seat frame extend in inclined relation with one another, and a reclined position, whereat the back frame and the seat frame extend in generally coplanar relation with one another.

In accordance with another aspect of the disclosure, a leg rest frame is supported by the seat frame for pivotal movement between a downward position, whereat the leg rest frame and the seat frame extend in inclined relation with one another, and a raised position, whereat the leg rest frame and the seat frame extend in generally coplanar relation with one another.

In accordance with another aspect of the disclosure, a seat cushion is supported by the seat frame and a back cushion supported by the back frame, wherein the seat cushion has a side extending along a sidewall of the vehicle in spaced relation from the sidewall by a first distance when the seat assembly is in the drive mode, wherein the back cushion has a back surface extending along the sidewall of the vehicle in spaced relation from the sidewall by a second distance when the seat assembly is in the sunset mode, wherein the first distance and the second distance are less than 8 inches.

In accordance with another aspect of the disclosure, the first distance and the second distance are less than 4 inches.

In accordance with another aspect of the disclosure, the sidewall does not interfere with the seat cushion and the back cushion as the seat assembly moves between the drive mode and the sunset mode.

In accordance with another aspect of the disclosure, a method of operating a seat assembly for a motor vehicle that is positioned adjacent an interior wall of the motor vehicle is provided. The method includes releasing a cushion frame of the seat assembly from a drive mode position facing forwardly in the motor vehicle and moving the cushion frame, relative to a fixed base frame, along an arced path not having a single axis of rotation to a sunset mode position facing laterally in the vehicle, generally ninety degrees from the drive mode.

In accordance with another aspect of the disclosure, the method further includes causing a first lever coupling the cushion frame to the base frame to pivot relative to the base frame in a first direction while moving the cushion frame from the drive mode position toward the sunset mode position and causing a second lever coupling the cushion frame to the base frame to pivot relative to the base frame in a second direction opposite the first direction while moving the cushion frame from the drive mode position toward the sunset mode position.

### BRIEF DESCRIPTION OF THE DRAWINGS

A more detailed description is set forth below with reference to example embodiment described in the appended figures. Understanding that these figures depict only example embodiments of the disclosure and are, therefore, not to be considered limiting of its scope. The disclosure is described and explained with added specificity and detail through the use of the accompanying drawings in which:

FIG. 1 is a perspective view of an example embodiment of a seat assembly constructed in accordance with an aspect of the disclosure in a drive mode;

FIG. 2 is a perspective view of the exemplary embodiment of the seat assembly in a sleep mode;

FIG. 3 is a perspective view of the exemplary embodiment of the seat assembly in a sunset mode;

FIG. 4 is a side elevation view of a frame assembly of the exemplary embodiment of the seat assembly in the drive mode;

FIG. 5 is a side elevation view of the frame assembly of the exemplary embodiment of the seat assembly in the drive mode and with a leg rest raised;

FIG. 6 is a side elevation view of the frame assembly of the exemplary embodiment of the seat assembly in the sleep mode;

FIG. 7 is a perspective view of a mounting assembly of the exemplary embodiment of the frame assembly shown in a position corresponding to the drive mode;

FIG. 8 is a top view of the exemplary embodiment of the frame assembly in the drive mode;

FIG. 9 is a top view of the exemplary embodiment of the frame assembly during an initial stage of swinging motion from the drive mode to the sunset mode;

FIG. 10 is a top view of the exemplary embodiment of the frame assembly at an advanced intermediate stage of the swinging motion from the drive mode to the sunset mode;

FIG. 11 is a top view of the exemplary embodiment of the frame assembly in the sunset mode; and

FIG. 12 is a fragmented view of the frame assembly showing a crash safety feature of the exemplary embodiment of the frame assembly.

### DETAILED DESCRIPTION OF THE EXEMPLARY EMBODIMENT

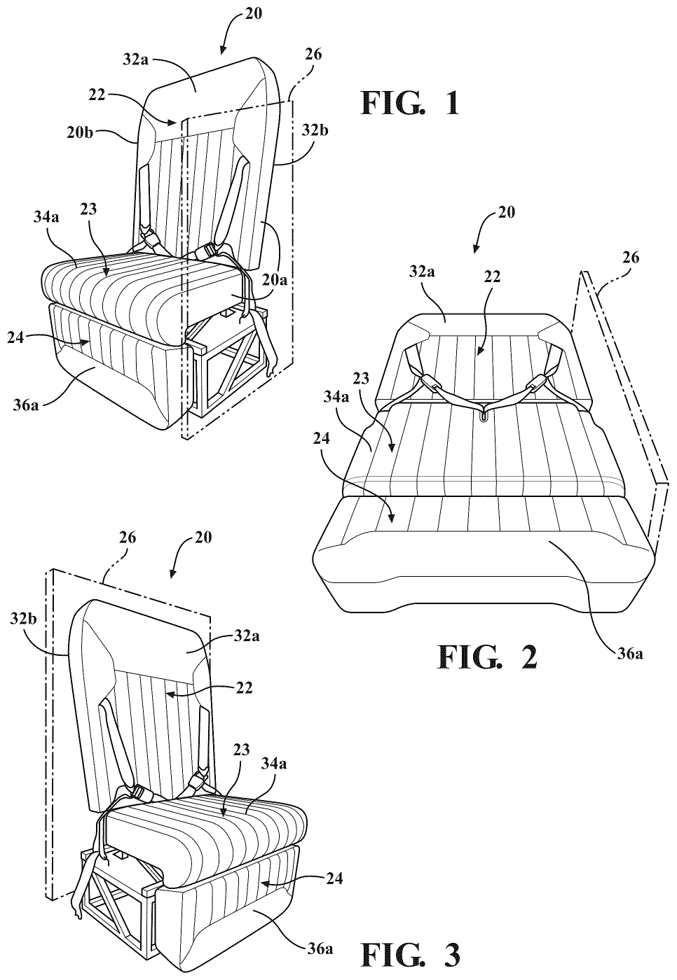

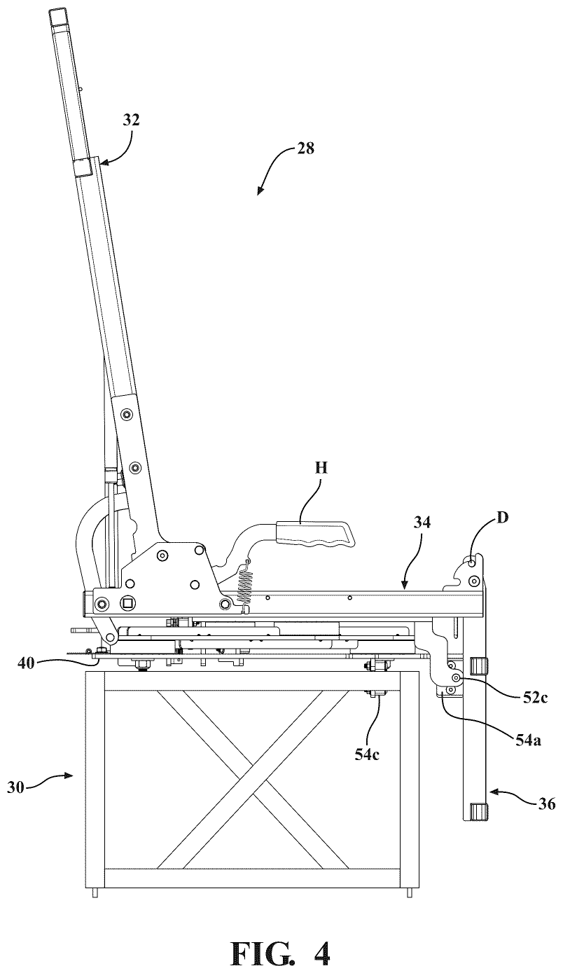

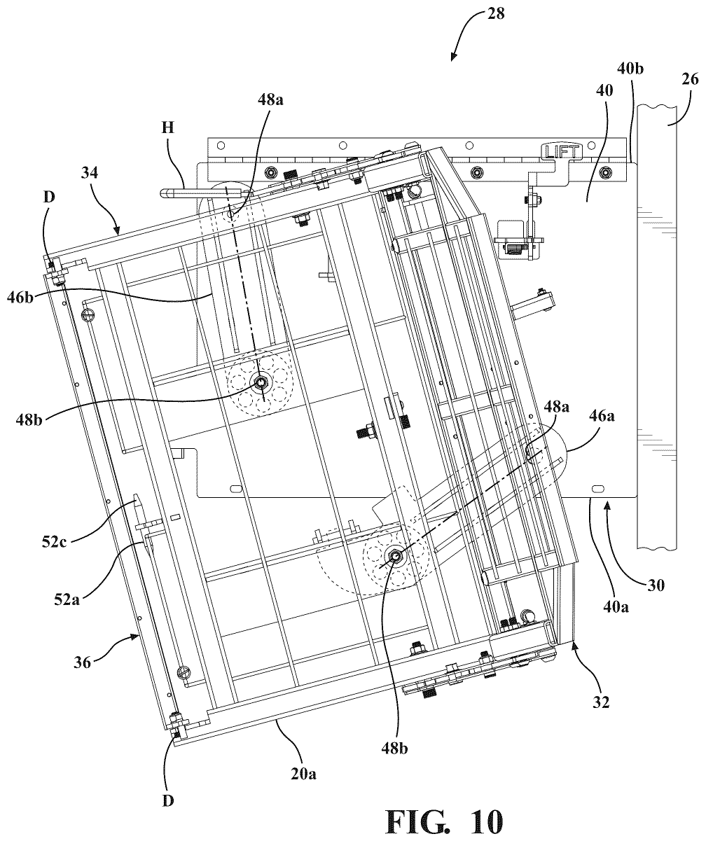

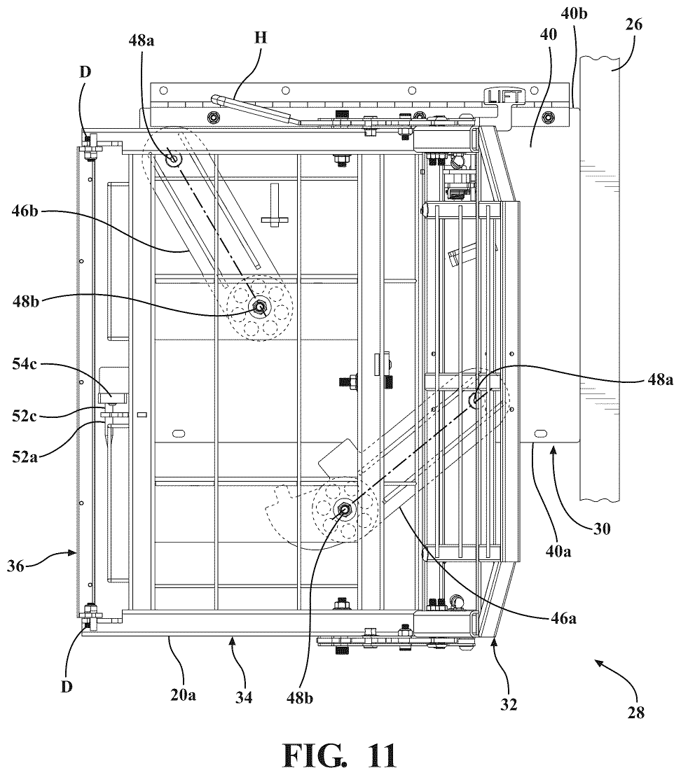

One aspect of the present disclosure is related to an improved seat assembly, also referred to as seat or sleeper seat 20, for a vehicle, such as an RV. As discussed in further detail below, the sleeper seat 20 is able to be adjusted between three different modes or configurations: a forward facing “drive mode,” a “sleep mode,” and a side facing “sunset mode.” When the sleeper seat 20 is in the drive mode, which is illustrated generally in FIG. 1, the sleeper seat 20 faces forwardly in the vehicle toward a front end of the vehicle so that one or two passengers (side-by-side) can sit comfortably and safely (while seat belted) on a generally horizontal sitting surface 23, and lean back against a seat back, also referred to as back rest 22, while in an upright position and while the vehicle is in motion. When the sleeper seat 20 is in the sleep mode, which is illustrated generally in FIG. 2, the sleeper seat 20 remains facing forwardly, but the back rest 22 of the sleeper seat 20 has been reclined, also referred to as lowered, from the upright position to a horizontal position into generally coplanar relation with the sitting surface 23, and a leg rest 24 has been raised upwardly from a lowered, generally vertically extending position to a horizontal position into generally coplanar relation with the sitting surface 23 to present a generally flat sleeping surface. Accordingly, the seat back 22, the sitting surface 23, and leg rest 24 of the sleeper seat 22, when in generally coplanar relation with one another, define the sleeping surface. With the back rest 22 in the upright position, the sleeper seat 20 can swing (not pivot about a single vertical axis) between the drive mode, where the sleeper seat 20 faces forwardly toward the front of the vehicle, and the sunset mode (generally illustrated in FIG. 3 and discussed in more detail hereafter) where the sleeper seat 20 faces a side of vehicle in a laterally oriented direction, or approximately ninety degrees relative to the forward direction of the vehicle, such that the back rest 22 faces a side of the vehicle, rather than facing the front of the vehicle as in the drive mode. As discussed in further detail below, the swinging movement, as opposed to purely rotational movement about a single fixed axis, allows the sleeper seat 20 to rest in close proximity adjacent a wall 26 (illustrated in FIGS. 1-3, and 8-11), such as a sidewall 26 of the vehicle, with minimal clearance with the sidewall 26, such as about ½″ inch, when in each of the three different modes, while being able to move between the three different modes without the sidewall 26 interfering with the movement or contacting the sleeper seat 20. It will be understood by a person possessing ordinary skill in the art (POSA) that movement of the sleeper seat, being configured in close proximity to the wall, as discussed above, from a forward facing position to a laterally facing position would not be possible, due to interference issues between the sleeper seat and the wall 26 of the vehicle, if the sleeper seat 20 were to solely pivot about a single fixed axis, rather than swinging along an arced path in a compound movement via a 4 bar linkage system, as disclosed herein. In the exemplary embodiment, the vehicle is an RV, by way of example and without limitation, and the sleeper seat 20 faces towards a right-side passenger door of the RV when in the sunset mode. However, in some other embodiments, the sleeper seat 20 can find uses in a range of other vehicle types, e.g., busses, aircraft, boats, etc.

Referring now to FIGS. 4-6, the sleeper seat 20 (illustrated in full in FIGS. 1-3) includes a seat frame assembly, also referred to as frame assembly 28. The frame assembly 28 is mounted to a top surface of a frame 30 of a support base, shown as an enclosure, without any components of the frame assembly 28 projecting downwardly into the enclosure. Frame 30 of enclosure is fixed against movement to a floor of vehicle via any suitable fastening arrangement, such that during movement of sleeper seat 20, frame 30 remains fixed in space with the floor. In the exemplary embodiment where the sleeper seat 20 is located in an RV, the enclosure may contain heating equipment (not shown) for heating a cabin and water supply for the RV. By the frame assembly 28 not including any components that project downwardly internally into the enclosure, the sleeper seat 20 does not interfere with any such heating equipment, or other types of equipment that may be desired for location within the confines of the enclosure. In other embodiments, such as those where the sleeper seat 20 is in a different type of vehicle, the frame assembly 28 may sit on any suitable enclosure or other raised surface.

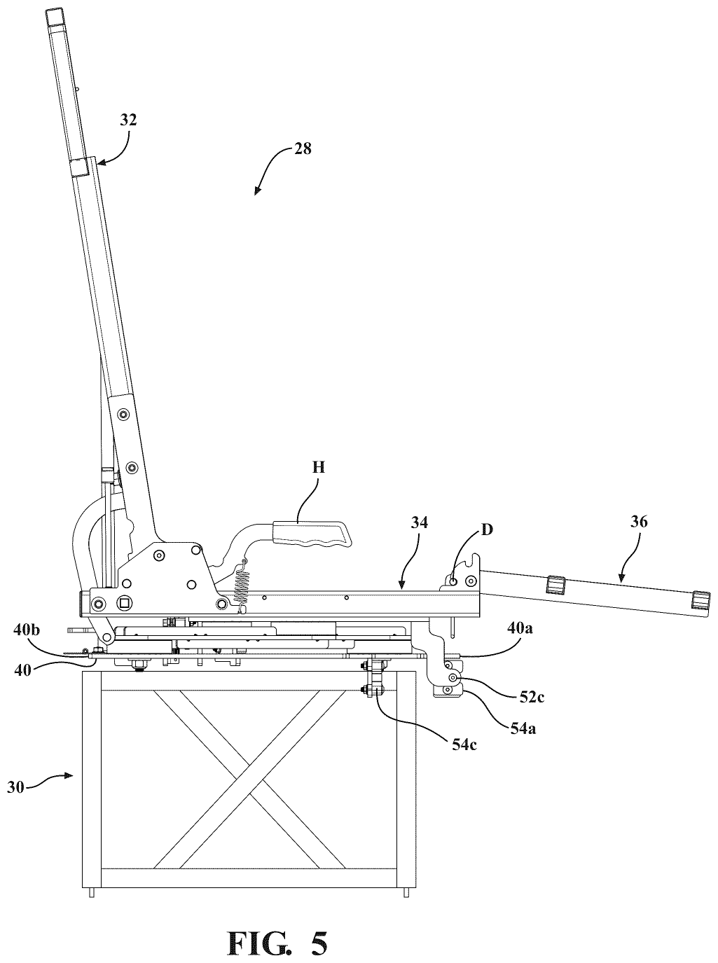

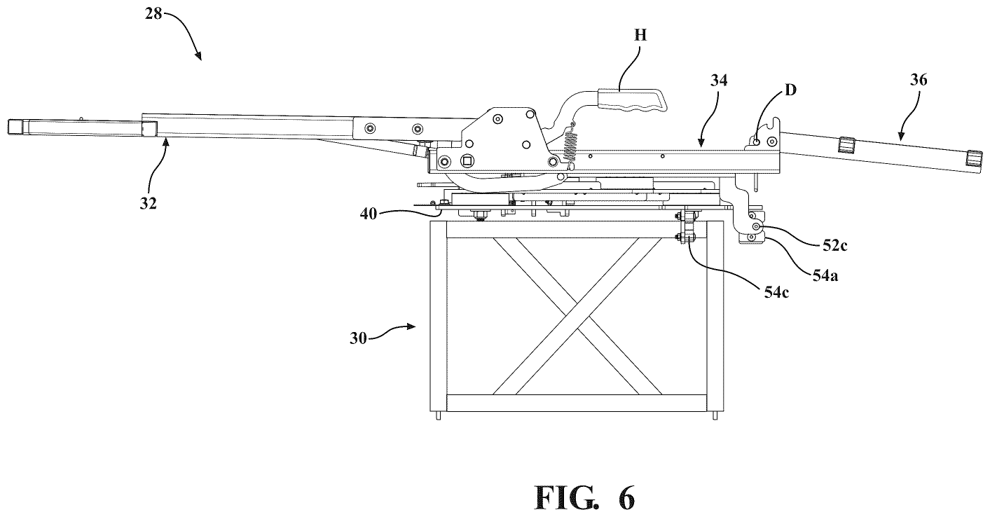

The frame assembly 28 is configured to support seat cushions, and includes a seat back frame, referred to hereafter as back frame 32 for supporting a back cushion 32a of back rest 22, a sitting surface frame, also referred to as seat frame or cushion frame 34 for supporting a sitting surface cushion, also referred to as seat cushion 34a, and a leg rest frame 36 for supporting a leg rest cushion 36a of leg rest 22. The back frame 32 is pivotably interconnected to the cushion frame 34, and the leg rest frame 36 is pivotably interconnected to the cushion frame 34. More specifically, the back frame 32 is pivotably connected with the cushion frame 34 so that the back frame 32 can tilt or pivot between the upright position illustrated in FIGS. 4 and 5, whereat the back frame 32 and the cushion frame 34 extend in inclined relation with one another, and the reclined position illustrated in FIG. 6, whereat the back frame 32 and the cushion frame 34 extend in generally coplanar relation with one another, such as is desired when the sleeper seat 20 is in the sleep mode. Similarly, the leg rest frame 36 can pivot between a non-deployed, downward position illustrated in FIG. 4, whereat the leg rest frame 36 and the cushion frame 34 extend in inclined relation with one another, and a deployed, raised position illustrated in FIGS. 5 and 6, whereat the leg rest frame 36 and the cushion frame 34 extend in generally coplanar relation with one another. The leg rest frame 36 can be raised when the sleeper seat 20 is in either the drive mode or the sunset mode. The back frame 32 and leg rest frame 36 can either be tilted manually by the user, such as by the user pulling one or more handles (H), push buttons, or detent mechanisms (D) to temporarily disengage latching mechanisms and reengage the mechanisms that lock the back frame 32 and leg rest frame 36 with the cushion frame 34, or automatically with one or more actuators (e.g., electric motors, not shown).

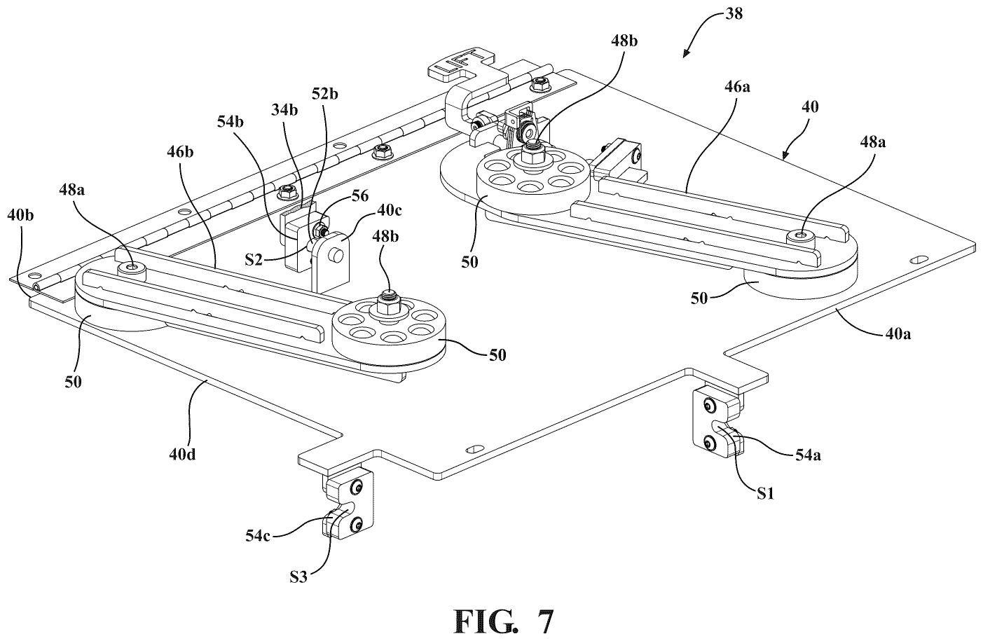

FIG. 7 depicts an exemplary embodiment of a mounting assembly 38 for mounting the cushion frame 34 for selected movement on top of the enclosure frame 30 and for facilitating the precisely guided swinging movement of the sleeper seat 20 between the drive mode and the sunset mode. The mounting assembly 38 includes a mount frame, also referred to as base frame 40 fixedly and operably attached (for example, with a plurality of threaded fasteners, by way of example and without limitation, not shown) to a floor surface (not shown) of the vehicle, and in the exemplary embodiment, fixedly attached directly to the enclosure frame 30, with the enclosure frame 30 being fixedly attached directly to the floor surface of the vehicle. Accordingly, the base frame 40 remains fixed against movement with the enclosure frame 30 during movement of sleeper seat 20 between the drive mode and sunset mode. The base frame 40 provides a mount surface for other components of the mounting assembly 38.

As illustrated in FIGS. 7-11, the mounting assembly 38 functions as a four-bar (4 bar) linkage to allow the sleeper seat 20 to swing between the drive mode and the sunset mode. In the four-bar linkage, the base frame 40 functions as a fixed ground link, and thus, does not move; the cushion frame 34 functions as a movable output link, and a pair of spaced apart, elongate first and second links, also referred to as first and second levers 46a, 46b, respectively, and referred to hereafter as levers 46a, 46b, that allow the cushion frame 34 to move in swinging, arced relation relative to the base frame 40. The pair of levers 46a, 46b are pivotably fixed to the base frame 40, and the seat frame assembly 28 is pivotably fixed to the pair of levers 46a, 46b, as discussed further hereafter. The seat frame assembly 28 moves relative to the base frame 40 about an arced path, wherein the arced path does not having a single axis of rotation. As such, the mounting assembly 38 allows the seat assembly 20 to be positioned in such close proximity with the sidewall 26, such that if purely rotational movement of the cushion frame 34 and cushion 34a thereon and back rest frame 32 and cushion 32a thereon about a single fixed axis of rotation (not shown, but similar to that of a seat on a bar stool or wheel on an axle, by way of example only) were to be attempted, the sidewall 26 would interfere with an prevent the purely rotational movement of the seat assembly 20. However, the mounting assembly 38, in accordance with the disclosure, allows swinging movement of the seat assembly 20 relative to the sidewall 26, to provide a swinging motion of the seat assembly 20 from the drive mode to the sunset mode without inference or contact with the sidewall 26.

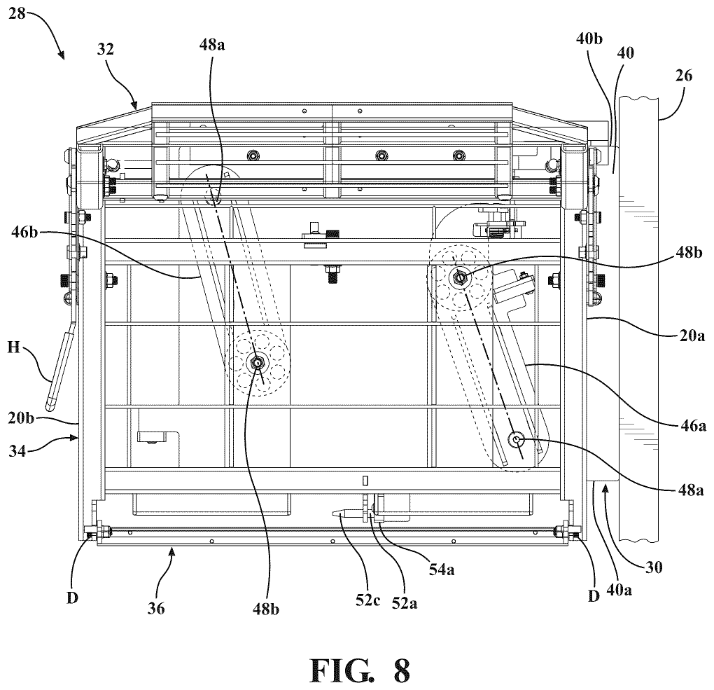

Each of the elongate levers 46a, 46b includes two pivot joints that separately pivotably attach the levers 46a, 46b with both the base frame 40 and the cushion frame 34, respectively. More specifically, each of the levers 46a, 46b includes a first pivot joint 48a that is located adjacent, also referred to as proximate, one end of the lever 46a, 46b, with the first pivot joint 48a attaching the respective lever 46a, 46b with the base frame 40, and with the first pivot joint 48a being decoupled from the cushion frame 34. Further, each of the levers 46a, 46b includes a second pivot joint 48b that is located adjacent, also referred to as proximate, an opposite end of the lever 46a, 46b from the respective first pivot joint 48a, with the second pivot joint 48b attaching the respective lever 46a, 46b with the cushion frame 34, and with the second pivot joint 48b being decoupled from the base frame 40. The first and second pivot joints 48a, 48b are specifically positioned at locations that only allow the output link (the cushion frame 34 and the sleeper seat 20 attached thereto) to swing in arced, oscillating fashion along an arced path between the drive mode, which is illustrated in FIG. 8, and the sunset mode, which is illustrated in FIG. 11. In FIGS. 13 and 14, the mounting assembly 38 is illustrated at two different moments in time of movement of sleeper seat 20 between the drive mode and the sunset mode. A location of a fixed sidewall 26 of the RV is depicted in FIGS. 8-11. As illustrated, throughout the swinging motion of sleeper seat 20 between the drive mode and the sunset mode, the sidewall 26 does not interfere with the free movement of the sleeper seat 20 and internal frame assembly of the sleeper seat 20 when it is in the drive mode or when in the sunset mode, or at any location of movement between the drive mode and sunset mode. When swinging from the sunset mode to the drive mode, the sleeper seat 20 follows the exact same guide path that it follows when swinging from the drive mode to the sunset mode, i.e., in reverse, such that the mounting assembly 38 only allows the sleeper seat 20 to follow a single arced path of movement when swinging between the two positions of drive mode and sunset mode. Accordingly, in view of the above, it should be recognized that the mount surface provided by base frame 40 is configured to remain fixed during movement of the sleeper seat 20 from the drive mode to the sunset mode, and that the cushion frame 34 is configured to move relative to the mount surface of base frame 40 during movement of the sleeper seat 20 from the drive mode to the sunset mode.

During movement of the sleeper seat 20 from the drive mode to the sunset mode, and from the sunset mode back to the drive mode, the cushion frame 34 does not have a fixed axis of rotation with the base frame 40 as the cushion frame 34 moves relative to the base frame 40. Accordingly, a fixed point on the cushion frame 34 does not rotate about a fixed point on the mount surface provided by base frame 40 as the cushion frame 34 moves relative to the mount surface of base frame 40, as will be understood by a POSA. Thus, it is to be recognized that the movement of cushion frame 34 is not purely rotational about a fixed axis of rotation, but rather, has a compound movement including translation along an arced path relative to the base frame 40. This allows a side 20a of sleeper seat 20 to extend along the fixed wall 26 in closed proximity, such as less than 8 inches, and preferably less than 4 inches, and in an exemplary embodiment, about 0.5 inch, by way of example and without limitation, while the sleeper seat 20 is in the drive mode, while then being able to move sleeper seat 20 to the laterally facing sunset mode to bring a back surface 32b of back cushion 32a of sleeper seat 20 into the same or substantially the same (substantially is intended to mean close proximity, such as +/− about 4 inch or less) spaced relation with fixed wall 26 without causing interference of sleeper seat 20 with fixed wall 26 during movement. The arced path of movement, including compound rotation and translation, allows the sleeper seat 20 to traverse in substantially the same spaced relation with fixed wall 26, and thus, prevents the sleeper seat 20 from having to move away from the wall 26 during movement. As such, nothing with vehicle needs to be moved or otherwise adjusted to permit sleeper seat 20 to transition from the drive mode to the sunset mode, as will be understood by a person possessing ordinary skill in the art upon viewing the disclosure herein.

Referring back to FIG. 8, illustrated corresponding to the drive mode, the first pivot joint 48a of a first of the levers 46a is coupled to the base frame 40, with the first pivot joint 48a of lever 46a located adjacent, also referred to as proximate, one side 40a extending along a front, forward facing portion of the base frame 40, with the second pivot joint 48b of the same lever 46a being located adjacent, also referred to as proximate, an opposite side 40b extending along a back, rearwardly facing portion of the base frame 40. Meanwhile, the first pivot joint 48a (also referred to as third pivot joint 48a to avoid confusion with the first pivot joint 48a of the first lever 46a) of the other lever 46b is coupled to the base frame 40, with the first pivot joint 48a of lever 46b located adjacent, also referred to as proximate, the rearward side 40b of the base frame 40, with the second pivot joint 48b (also referred to as fourth pivot joint 48b to avoid confusion with the second pivot joint 48b of the first lever 46a) of the same lever 46b being located adjacent, also referred to as proximate, the forward facing side 40a of the base frame 40. In the exemplary embodiment, the pivot joints 48a, 48b include bolts and bearings 50 (only identified in FIG. 7 to avoid cluttering the remaining FIGS.) to establish the pivotal connections between the levers 46a, 46b and the base frame 40 and cushion frame 34. However, any suitable single-axis rotational means can be employed, e.g., bushings.

As illustrated in FIG. 8, in the exemplary embodiment, the sleeper seat 20 has a width extending between opposite sides 20a, 20b, with one side 20a extending along and facing the wall 26 while in the drive mode, and the opposite side 20b facing away from the wall 26 while in the drive mode. The width of the sleeper seat 20 is greater than a width of the enclosure frame 30. When the sleeper seat 20 is in the drive mode of FIG. 8, the side 20b of sleeper seat 20 facing away from the wall 26 extends in cantilevered fashion beyond a laterally inwardly facing side of the enclosure frame 30 facing away from the wall 26 such that side 20b of sleeper seat 20 overhangs the laterally inwardly facing side of enclosure frame 30 by a first distance, whereupon neither of the levers 46a, 46b extend beyond the enclosure frame 30 while in the drive mode. Turning now to FIG. 11, when the sleeper seat 20 is in the sunset mode, one of the levers 46a extends outwardly past a forward facing edge of the enclosure frame 30 and the side 20a of sleeper seat 20 overhangs the forward facing edge of the enclosure frame 30 in cantilevered fashion by a second distance that is greater than the first distance. In the exemplary embodiment, the sleeper seat 20 can lock in either drive mode or the sunset mode via any suitable locking mechanism.

While in the drive mode, the side 20a of sleeper seat 20 is able to be positioned in close proximity with wall 26, such that a minimal clearance, such as about 0.5-1.0 inch, for example, is provided between side 20a of sleeper seat and wall 26 to minimize the amount interior space of the vehicle occupied by the sleeper seat 20. The minimal clearance between the side 20a and the wall 26 is able to be provided due to the path of swinging movement of the sleeper seat 20 between the drive mode and the sunset mode. As shown in FIGS. 8-11, the amount of clearance of sleeper seat 20 and the wall 26 remains substantially constant, meaning the clearance can vary slightly, but not into engagement with the wall 26. Accordingly, while in the sunset mode, a back surface of sleeper seat 20, provided substantially be a back surface 32b of back cushion 32a supported by back frame 32, is located in close proximity with wall 26, such that a minimal clearance, such as about 0.5-1.0 inch, for example, is maintained. As stated, this minimal clearance is maintained or substantially maintained between the sleeper seat 20 and wall 26 throughout the entirety of movement of sleeper seat 20 between the drive mode and sunset mode. The clearance is able to be maintained due to the paths of movement of the levers 46a, 46b of the 4 bar linkage mechanism.

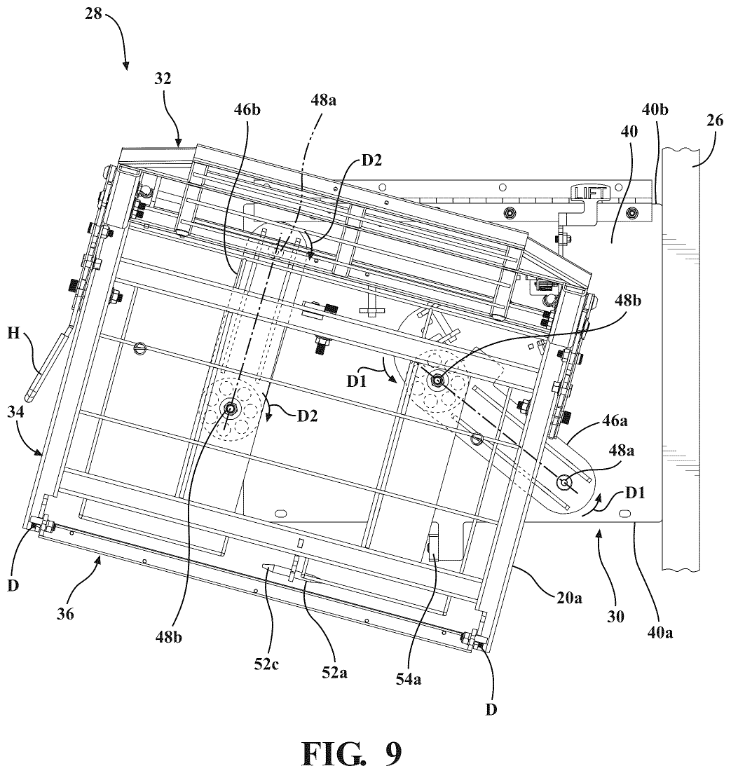

As shown in FIG. 8, while in the drive mode, the levers 46a, 46b are in generally parallel relation with one another. Then, upon movement to the sunset mode (FIG. 11), the levers 46a, 46b are in nonparallel, substantially transverse relation with one another. During movement of sleeper seat 20 from the drive mode to the sunset mode, referring to FIG. 9, with reference to base frame 40, which remains permanently fixed in space and permanently fixed to vehicle, lever 46a pivots in a first direction D1, shown as counterclockwise, about pivot joint 48a fixed to base frame 40, while lever 46b pivots in a second direction D2, shown as clockwise, opposite the first direction D1 about pivot joint 48a fixed to base frame 40, and with reference to cushion frame 34, lever 46a pivots in the first direction D1, counterclockwise about pivot joint 48b fixed to cushion frame 34, while lever 46b pivots in the second direction D2, clockwise about pivot joint 48b fixed to cushion frame 34. Accordingly, levers 46a, 46b move out from parallel relation with one another, while in the drive mode, to a nonparallel relation upon movement from the drive mode to the sunset mode. The levers 46a, 46b are provided in the non-limiting embodiment having the same length, and thus, the 4 bar linkage of mounting assembly 38 is generally symmetrical. It is contemplated herein that a nonsymmetrical 4 bar linkage arrangement could be employed, such that levers could be provided having different lengths from one another, depending on the path of movement desired for the sleeper seat 20.

In the exemplary embodiment, while the back frame 32 cannot be reclined when the sleeper seat 20 is in the sunset mode due to the location of the wall 26, the leg rest frame 36 is able to be raised when the sleeper seat 20 is in either the drive mode or the sunset mode. In some other embodiments where the sleeper seat is not located adjacent a wall, then the back frame may be able to recline when it is in the sunset mode.

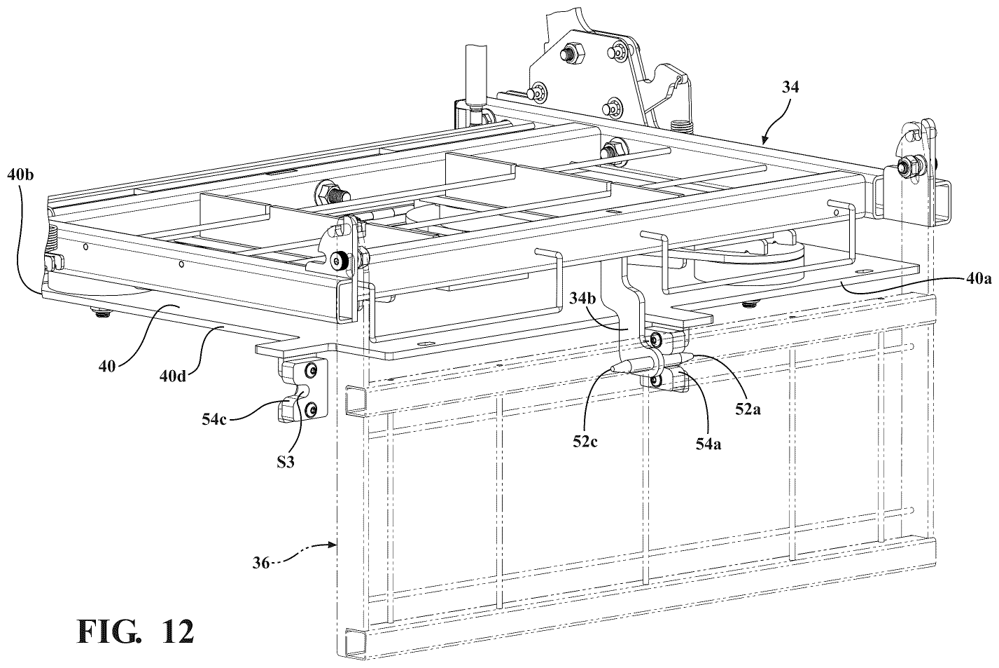

Referring back to FIG. 7, a first safety bracket, also referred to as first safety detent 54a, is permanently fixed to the base frame 40 adjacent side 40a extending along the front, forward facing portion of the base frame 40. First safety detent 54a has a generally u-shaped first receptacle, also referred to as first slot S1, configured for receipt of a first pin 52a (FIG. 8) therein while sleeper seat 20 is in the drive mode. First slot S1 faces forwardly and opens toward the front of vehicle in fixed relation with first safety detent 54a, and thus, remains forward facing regardless of the position of the cushion frame 34. First pin 52a is operably fixed to cushion frame 34, shown as being fixed to cushion frame 34 via a bracket 34b (FIG. 12) that is fixed directly to cushion frame 34, such via any suitable fastening mechanism, such as via a weld joint, by way of example and without limitation. As such, first pin 52a swings with cushion frame 34 as cushion frame 34 swings between the drive mode and sunset mode, wherein first pin 52a is received within first slot S1 to extend laterally through the first slot S1 while sleeper seat 20 is in the drive mode, thereby being captured therein while cushion frame 34 remains in the drive mode. Upon sleeper seat 20 being moved to the sunset mode, first pin 52a is withdrawn from first slot S1. A second safety bracket, also referred to as second safety detent 54b, is operably fixed to the cushion frame 34, shown as being fixed to cushion frame 34 via a bracket 34b that is permanently fixed directly to cushion frame 34. Second safety detent 54b is permanently fixed to bracket 34b via any suitable fastening mechanism, such as one or more threaded fasteners 56. As such, second safety detent 54b moves with cushion frame 34 as cushion frame 34 swings between the drive mode and the sunset mode. Second safety detent 54b has a generally u-shaped receptacle, also referred to as second slot S2, configured for receipt of a second pin 52b (FIG. 8) therein while sleeper seat 20 is in the drive mode. Second pin 52b is operably fixed to base frame 40, shown as being permanently fixed to base frame 40 via a bracket 40c that is permanently fixed directly to base frame 40, such via any suitable fastening mechanism, such as via a weld joint, by way of example and without limitation. Second pin 52b is fixed to extend lengthwise along the length of the vehicle, and in the non-limiting embodiment, toward the rear of the vehicle. As such, second detent 54b swings with cushion frame 34 as cushion frame 34 swings between the drive mode and sunset mode, wherein second pin 52b is received within second slot S2 to extend lengthwise relative to the vehicle length through the second slot S2 while sleeper seat 20 is in the drive mode, thereby being captured therein while cushion frame 34 remains in the drive mode. Accordingly, when second pin 52b is received with second slot S2, second slot S2 opens laterally toward a side of the vehicle. Upon sleeper seat 20 being moved to the sunset mode, second pin 52b is withdrawn from second slot S2 as second detent 54b swings in fixed relation with cushion frame 34.

In the event that the vehicle is involved in a rearward collision and other components of the mounting assembly 38 fail due to extreme forces from the impact, then the first pin 52a will be restrained with the receptacle of first safety detent 54a, thus, keeping cushion frame 34 from tilting rearwardly, thereby holding the sleeper seat 20 in fixed relation with base frame 40 and enclosure frame 30, thereby protecting any occupants in the sleeper seat 20. In the event that the vehicle is involved with a forward collision and other components of the mounting assembly 38 fail due to extreme forces from the impact, then the second pin 52b will be restrained with the receptacle of second safety detent 54b, thus, keeping cushion frame 34 from tilting forwardly, thereby holding the sleeper seat 20 in fixed relation with base frame 40 and enclosure frame 30, thereby protecting any occupants in the sleeper seat 20. In addition to the rearward and forward collision safety provided, further safety is provided via holding the sleeper seat 20 in fixed relation with base frame 40 and enclosure frame 30 by pins 52a, 52b being received in their respective safety detents 54a, 54b in the event of a side impact.

A third safety bracket, also referred to as third safety detent 54c, is permanently fixed to the base frame 40 adjacent a laterally facing side 40d extending along a side, laterally facing portion of the base frame 40. Third safety detent 54c has a generally u-shaped receptacle, also referred to as third slot S3, configured for receipt of a third pin 52c (FIG. 11) therein while sleeper seat 20 is in the sunset mode. Third slot S3 faces laterally toward a side of vehicle and opens toward the side of vehicle in fixed relation with third safety detent 54c, and thus, remains laterally facing regardless of the position of the cushion frame 34. Third pin 52c is operably fixed to cushion frame 34, shown as being fixed to cushion frame 34 via the bracket 34b (FIG. 12). Third pin 52c is shown as a lengthwise extension of first pin 52a, with first and third pins 52a, 52c being formed as a single piece of material extending through an opening in bracket 34b, with bracket 34b bisecting the single piece of material such the first and third pins 52a, 52c extending away from opposite sides of bracket 34b, by way of example and without limitation. As such, third pin 52c swings with cushion frame 34 as cushion frame 34 swings from the drive mode to sunset mode, whereupon third pin 52c is swung into receipt within third slot S3 to extend lengthwise relative to the vehicle length through the third slot S3 while sleeper seat 20 is in the sunset mode, thereby being captured therein while cushion frame 34 remains in the sunset mode. Accordingly, when third pin 52c is received with third slot S3 while sleeper seat 20 is in the sunset mode, third slot S3 opens laterally toward a side of the vehicle. Upon sleeper seat 20 being moved from the sunset mode to the drive mode, third detent 54c remains fixed in place, while third pin 52c is withdrawn from third slot S2 in fixed relation with cushion frame 34. In the event that the vehicle is involved in a forward, rearward, or side collision while sleeper seat 20 is in the sunset mode, and other components of the mounting assembly 38 fail due to extreme forces from the impact, then the third pin 52c will be restrained with the third slot S3 of third safety detent 54c, thus, keeping cushion frame 34 from tilting rearwardly, forwardly, or laterally, thereby holding the sleeper seat 20 in fixed relation with base frame 40 and enclosure frame 30, thereby protecting any occupants in the sleeper seat 20.

In accordance with another aspect of the disclosure, a method of operating a seat assembly 20 for a motor vehicle that is positioned adjacent an interior wall 26 of the motor vehicle is provided. The method includes releasing a cushion frame 34 of the seat assembly 20 from a drive mode position facing forwardly in the motor vehicle and moving the cushion frame 34, relative to a fixed base frame 40, along an arced path not having a single axis of rotation to a sunset mode position facing laterally in the motor vehicle, generally ninety degrees from the drive mode.

In accordance with another aspect of the disclosure, the method further includes causing a first lever 46a coupling the cushion frame 34 to the base frame 40 to pivot relative to the base frame 40 in a first direction D1 while moving the cushion frame 34 from the drive mode position toward the sunset mode position and causing a second lever 46b coupling the cushion frame 34 to the base frame 40 to pivot relative to the base frame 40 in a second direction D2 opposite the first direction D1 while moving the cushion frame 34 from the drive mode position toward the sunset mode position.

The foregoing disclosure provides illustration and description but is not intended to be exhaustive or to limit the implementations to the precise form disclosed. Although particular combinations of features are recited in the claims and/or disclosed in the specification, these combinations are not intended to limit the disclosure of various implementations. In fact, many of these features may be combined in ways not specifically recited in the claims and/or disclosed in the specification. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A seat assembly for a vehicle movable from a drive mode facing forwardly to a sunset mode facing laterally generally ninety degrees from the drive mode, comprising: a mount surface;
a seat frame;
a first lever pivotably coupled to said mount surface by a first pivot joint such that said first lever is pivotal relative to said mount surface about said first pivot joint, said first lever pivotably coupled to said seat frame by a second pivot joint such that said first lever is pivotal relative to said seat frame about said second pivot joint; and
a second lever pivotably coupled to said mount surface by a third pivot joint such that said second lever is pivotal relative to said mount surface about said third pivot joint, said second lever pivotably coupled to said seat frame by a fourth pivot joint such that said second lever is pivotal relative to said seat frame about said fourth pivot joint.

2. The seat assembly of claim 1, wherein the first lever and the second lever are generally parallel with one another while the seat assembly is in the drive mode, and the first lever and the second lever are in nonparallel relation with one another while the seat assembly is in the sunset mode.

3. The seat assembly of claim 1, wherein the mount surface extends between opposite sides, the first pivot joint being proximate one of the opposite sides and the third pivot joint being proximate the other of the opposite sides.

4. The seat assembly of claim 3, wherein the first pivot joint and the third pivot joint are decoupled from the seat frame.

5. The seat assembly of claim 4, wherein the second pivot joint and the fourth pivot joint are decoupled from the mount surface.

6. The seat assembly of claim 1, wherein the vehicle seat has a side extending along a sidewall of the vehicle when the seat assembly is in the drive mode, wherein the sidewall does not interfere with the side of the seat assembly as the seat assembly moves between the drive mode and the sunset mode.

7. The seat assembly of claim 6, wherein the side of the seat assembly is spaced from the sidewall by a first distance while the vehicle seat is in the drive mode, and wherein the seat assembly has a back surface spaced from the sidewall by a second distance while the seat assembly is in the sunset mode, wherein the first distance is substantially the same as the second distance.

8. The seat assembly of claim 7, wherein the vehicle seat is spaced from the sidewall substantially by the first distance or substantially by the second distance throughout the entirety of the movement of the seat assembly between the drive mode and the sunset mode.

9. The seat assembly of claim 1, wherein said first lever pivots relative to said mount surface about said first pivot joint in a first direction while the seat assembly moves from the drive mode to the sunset mode and the second lever pivots relative to said mount surface about said third pivot joint in a second direction opposite the first direction while the seat assembly moves from the drive mode to the sunset mode.

10. The seat assembly of claim 9, wherein said first lever pivots relative to said seat frame about said second pivot joint in the first direction while the seat assembly moves from the drive mode to the sunset mode and the second lever pivots relative to said seat frame about said fourth pivot joint in the second direction while the seat assembly moves from the drive mode to the sunset mode.

11. The seat assembly of claim 1, wherein said mount surface is configured to remain fixed during movement of the seat assembly from the drive mode to the sunset mode, and said seat frame is configured to move relative to said mount surface during movement of the seat assembly from the drive mode to the sunset mode, said seat frame not having a fixed axis of rotation with said mount surface as said seat frame moves relative to said mount surface.

12. The seat assembly of claim 11, wherein a fixed point on said seat frame does not rotate about a fixed point on said mount surface as said seat frame moves relative to said mount surface.

13. The seat assembly of claim 1, further including a back frame supported by said seat frame for pivotal movement between an upright position, whereat said back frame and said seat frame extend in inclined relation with one another, and a reclined position, whereat said back frame and said seat frame extend in generally coplanar relation with one another.

14. The seat assembly of claim 13, further including a leg rest frame supported by said seat frame for pivotal movement between a downward position, whereat said leg rest frame and said seat frame extend in inclined relation with one another, and a raised position, whereat said leg rest frame and said seat frame extend in generally coplanar relation with one another.

15. The seat assembly of claim 13, further including a seat cushion supported by the seat frame and a back cushion supported by the back frame, wherein said seat cushion has a side extending along a sidewall of the vehicle in spaced relation from the sidewall by a first distance when the vehicle seat is in the drive mode, wherein said back cushion has a back surface extending along the sidewall of the vehicle in spaced relation from the sidewall by a second distance when the seat assembly is in the sunset mode, wherein the first distance and the second distance are less than 4 inches.

16. The seat assembly of claim 15, wherein the sidewall does not interfere with said seat cushion and said back cushion as the vehicle seat moves between the drive mode and the sunset mode.

17. A seat assembly for a vehicle movable from a drive mode facing forwardly to a sunset mode facing laterally generally ninety degrees from the drive mode, comprising:
a mounting assembly having a base frame configured to be fixedly attached to a floor of the vehicle and a pair of levers pivotably fixed to the base frame; and
a seat frame pivotably fixed to the pair of levers,
wherein the seat frame moves relative to the base frame about an arced path, the arced path not having a single axis of pivotal movement.

18. The seat assembly of claim 17, wherein the pair of levers comprises:
a first lever pivotably coupled to said base frame by a first pivot joint, said first lever pivotably coupled to said seat frame by a second pivot joint; and
a second lever pivotably coupled to said base frame by a third pivot joint, said second lever pivotably coupled to said seat frame by a fourth pivot joint.

19. The seat assembly of claim 18, wherein said base frame extends between opposite sides, the first pivot joint being proximate one of the opposite sides and the third pivot joint being proximate the other of the opposite sides, wherein the first pivot joint and the third pivot joint are decoupled from the seat frame, wherein the second pivot joint and the fourth pivot joint are decoupled from the base frame.

20. A method of operating a seat assembly for a motor vehicle that is positioned adjacent an interior wall of the motor vehicle, comprising:
releasing a cushion frame of the seat assembly from a drive mode position facing forwardly in the motor vehicle; and
moving the cushion frame, relative to a fixed base frame, along an arced path not having a single axis of rotation to a sunset mode position facing laterally in the vehicle, generally ninety degrees from the drive mode.
